(19) United States
(12) Patent Application Publication
(10) Pub. No.: US 2023/0139088 A1
(43) Pub. Date: May 4, 2023

(54) ELECTRONIC DEVICE FOR PROVIDING VOICE RECOGNITION SERVICE AND OPERATING METHOD THEREOF

(71) Applicant: SAMSUNG ELECTRONICS CO., LTD., Suwon-si (KR)

(72) Inventor: Hyunju CHEON, Suwon-si (KR)

(21) Appl. No.: 17/980,356

(22) Filed: Nov. 3, 2022

Related U.S. Application Data
(63) Continuation of application No. PCT/KR2022/016806, filed on Oct. 31, 2022.

(30) Foreign Application Priority Data
Nov. 3, 2021 (KR) 10-2021-0150041
Dec. 20, 2021 (KR) 10-2021-0182640

(51) Int. Cl. G10L 15/22; G10L 15/18; G10L 15/30

(52) U.S. Cl. CPC G10L 15/22; G10L 15/18; G10L 15/30; G10L 2015/228; G10L 2015/223; H04L 67/12

(57) ABSTRACT

Disclosed is an electronic device including an input module, a processor, and a memory that stores instructions. The instructions, when executed by the processor, cause the electronic device to obtain a natural language input through the input module, to identify at least one external electronic device associated with at least one command according to the natural language input, to identify a specified external electronic device among the at least one external electronic device, to identify at least one first external electronic device associated with the specified external electronic device among the at least one external electronic device, to identify at least one operation performed by each of the specified external electronic device and the at least one first external electronic device by the at least one command, and to generate a rule for executing the at least one operation. Besides, other various embodiments identified through the specification are also possible.

### CROSS-REFERENCE TO RELATED APPLICATIONS

This application is based on and claims priority under 35 U.S.C. § 120 to PCT International Application No. PCT/KR2022/016806, which was filed on Oct. 31, 2022, and claims priority to Korean Patent Application No. 10-2021-0182640 filed on Dec. 20, 2021, and Korean Patent Application No. 10-2021-0150041 filed on Nov. 3, 2021, in the Korean Intellectual Property Office, the disclosure of which are incorporated by reference herein their entirety.

### TECHNICAL FIELD

Various embodiments disclosed in this specification relate to an electronic device that provides a voice recognition service, and an operating method thereof.

### BACKGROUND ART

Electronic devices, such as smart phones perform various complex functions. Several electronic devices are capable of recognizing a voice and perform functions responsively to improve manipulability.

Such voice recognition provides a user-friendly conversation service. For example, the electronic device provides a conversational user interface that outputs a response message in response to a voice input (e.g., a question, a command, etc.) from a user. The user may use his/her conversational language, i.e., natural language for such interactions. In some examples, the conversational user interface outputs messages in an audible format using the natural language.

### DISCLOSURE

### Technical Problem

When a user desires to control one or more functions of an electronic device or a plurality of electronic devices via a voice command, i.e., the conversational user interface, the user may say, i.e., utter, a plurality of utterances. The utterances may provide queries, commands, input parameters, etc., required to control one or more functions of an electronic device, or a plurality of electronic devices.

A technical challenge or problem exists to recognize pieces of intent of the user according to the plurality of utterances together, i.e., combined, and perform the operations as per the recognized pieces of intent.

### Technical Solution

According to an embodiment disclosed in this specification, an electronic device may include an input module, a processor, and a memory that stores instructions. The instructions may, when executed by the processor, cause the electronic device to perform several operations. For example, the electronic device may obtain a natural language input through the input module, to identify at least one external electronic device associated with at least one command according to the natural language input. The electronic device may further identify a specified external electronic device among the at least one external electronic device. The electronic device may further identify at least one first external electronic device associated with the specified external electronic device among the at least one external electronic device. The electronic device may further identify at least one operation performed by each of the specified external electronic device and the at least one first external electronic device by the at least one command. The electronic device may further generate a rule for executing the at least one operation.

According to an embodiment disclosed in this specification, an operating method of an electronic device may include obtaining a natural language input through an input module of the electronic device. The method further includes identifying at least one external electronic device associated with at least one command according to the natural language input. The method further includes identifying a specified external electronic device among the at least one external electronic device. The method further includes identifying at least one first external electronic device associated with the specified external electronic device among the at least one external electronic device. The method further includes identifying at least one operation performed by each of the specified external electronic device and the at least one first external electronic device by the at least one command. The method further includes generating a rule for executing the at least one operation.

### Advantageous Effects

An electronic device according to various embodiments disclosed in this specification may recognize and manage pieces of intent of related utterances as one rule by analyzing a plurality of utterances.

### DESCRIPTION OF DRAWINGS

FIG. 1 is a block diagram of an electronic device in a network environment, according to various embodiments of the disclosure.

FIG. 2 is a block diagram illustrating an integrated intelligence system, according to an embodiment.

FIG. 3 is a diagram illustrating a form in which relationship information between a concept and an action is stored in a database, according to an embodiment.

FIG. 4 is a view illustrating a screen in which a user terminal processes a voice input received through an intelligent app, according to an embodiment.

FIG. 5 illustrates a voice recognition service environment of an electronic device, according to an embodiment.

FIG. 6 is a flowchart illustrating an operation of an electronic device, according to an embodiment.

FIG. 7 is a flowchart illustrating an operation of an intelligent server, according to an embodiment.

FIG. 8A is a flowchart illustrating an operation of an intelligent server, according to an embodiment.

FIG. 8B illustrates a candidate list and a meta data.

FIG. 9 is a flowchart illustrating an operation of an intelligent server, according to an embodiment.

FIG. 10A is a flowchart illustrating an operation of an intelligent server, according to an embodiment.

FIG. 10B illustrates a candidate list and a meta data.

FIG. 11A is a flowchart illustrating an operation of an intelligent server, according to an embodiment.

FIG. 11B illustrates a candidate list and a meta data.

FIG. 12 is a flowchart illustrating an operation of an electronic device, according to an embodiment.

FIG. 13 is a flowchart illustrating an operation of an electronic device, according to an embodiment.

FIG. 14 illustrates a voice recognition service providing situation, according to an embodiment.

FIG. 15 illustrates a voice recognition service providing situation, according to an embodiment.

FIG. 16 illustrates a user interface of an electronic device, according to an embodiment.

FIG. 17 illustrates a voice recognition service providing situation, according to an embodiment.

FIG. 18 is a flowchart illustrating an operation of an electronic device, according to an embodiment.

With regard to description of drawings, the same or similar components will be marked by the same or similar reference signs.

### MODE FOR INVENTION

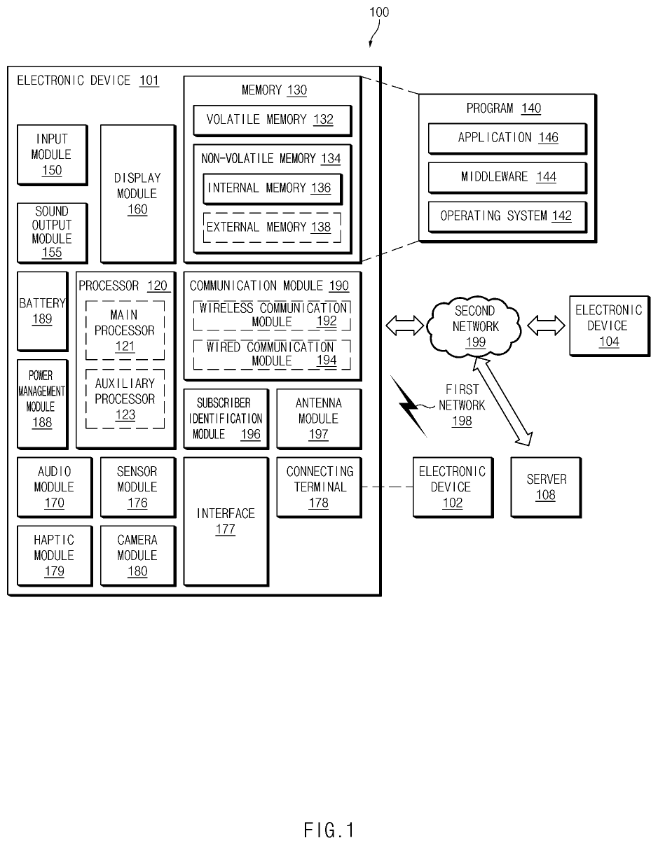

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

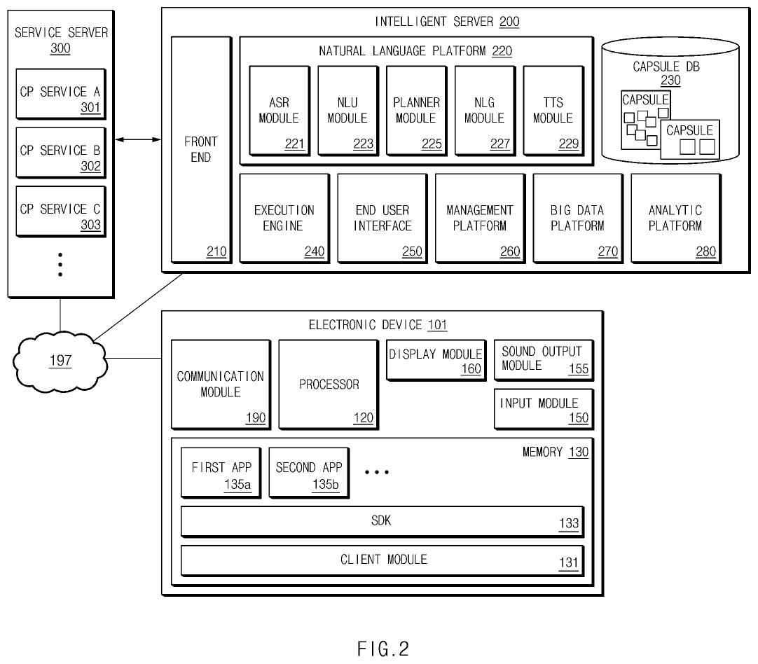

FIG. 2 is a block diagram illustrating an integrated intelligence system, according to an embodiment.

Referring to FIG. 2, an integrated intelligence system according to an embodiment may include the electronic device 101, an intelligent server 200, and a service server 300.

The electronic device 101 according to an embodiment may be a terminal device (or an electronic device) capable of connecting to Internet, and may be, for example, a mobile phone, a smartphone, a personal digital assistant (PDA), a notebook computer, a television (TV), a household appliance, a wearable device, a head mounted display (HMD), or a smart speaker.

According to the illustrated embodiment, the electronic device 101 may include the communication module 190, the input module 150, the sound output module 155, the display module 160, the memory 130, and/or the processor 120. The listed components may be operatively or electrically connected to one another.

The communication module 190 may be connected to an external device and may be configured to transmit or receive data to or from the external device. The input module 150 may receive a sound (e.g., a user utterance) to convert the sound into an electrical signal. The sound output module 155 may output the electrical signal as sound (e.g., voice). The display module 160 may be configured to display an image or a video. The display module 160 according to an embodiment may display the graphic user interface (GUI) of the running app (or an application program).

The memory 130 according to an embodiment may store a client module 131, a software development kit (SDK) 133, and a plurality of applications. The client module 131 and the SDK 133 may constitute a framework (or a solution program) for performing general-purposed functions. Furthermore, the client module 131 or the SDK 133 may constitute the framework for processing a voice input.

The plurality of applications (e.g., 135a and 135b) may be programs for performing a specified function. According to an embodiment, the plurality of applications may include a first app 135a and/or a second app 135b. According to an embodiment, each of the plurality of applications may include a plurality of actions for performing a specified function. For example, the applications may include an alarm app, a message app, and/or a schedule app. According to an embodiment, the plurality of applications may be executed by the processor 120 to sequentially execute at least part of the plurality of actions.

According to an embodiment, the processor 120 may control an overall operation of the electronic device 101. For example, the processor 120 may be electrically connected to the communication module 190, the input module 150, the sound output module 155, and the display module 160 to perform a specified operation. For example, the processor 120 may include at least one processor.

Moreover, the processor 120 according to an embodiment may execute the program stored in the memory 130 so as to perform a specified function. For example, according to an embodiment, the processor 120 may execute at least one of the client module 131 or the SDK 133 so as to perform a following operation for processing a voice input. The processor 120 may control operations of the plurality of applications via the SDK 133. The following actions described as the actions of the client module 131 or the SDK 133 may be the actions performed by the execution of the processor 120.

According to an embodiment, the client module 131 may receive a voice input. For example, the client module 131 may receive a voice signal corresponding to a user utterance detected through the input module 150. The client module 131 may transmit the received voice input (e.g., a voice input) to the intelligent server 200. The client module 131 may transmit state information of the electronic device 101 to the intelligent server 200 together with the received voice input. For example, the state information may be execution state information of an app.

According to an embodiment, the client module 131 may receive a result corresponding to the received voice input from the intelligent server 200. For example, when the intelligent server 200 is capable of calculating the result corresponding to the received voice input, the client module 131 may receive the result corresponding to the received voice input. The client module 131 may display the received result on the display module 160.

According to an embodiment, the client module 131 may receive a plan corresponding to the received voice input. The client module 131 may display, on the display module 160, a result of executing a plurality of actions of an app depending on the plan. For example, the client module 131 may sequentially display the result of executing the plurality of actions on the display module 160. For another example, the electronic device 101 may display only a part of results (e.g., a result of the last action) of executing the plurality of actions, on the display module 160.

According to an embodiment, the client module 131 may receive a request for obtaining information necessary to calculate the result corresponding to a voice input, from the intelligent server 200. According to an embodiment, the client module 131 may transmit the necessary information to the intelligent server 200 in response to the request.

According to an embodiment, the client module 131 may transmit, to the intelligent server 200, information about the result of executing a plurality of actions depending on the plan. The intelligent server 200 may identify that the received voice input is correctly processed, by using the result information.

According to an embodiment, the client module 131 may include a speech recognition module. According to an embodiment, the client module 131 may recognize a voice input for performing a limited function, via the speech recognition module. For example, the client module 131 may launch an intelligent app for processing a specific voice input by performing an organic action, in response to a specified voice input (e.g., wake up!).

According to an embodiment, the intelligent server 200 may receive information associated with a user's voice input from the electronic device 101 over a network 197 (e.g., the first network 198 and/or the second network 199 of FIG. 1). According to an embodiment, the intelligent server 200 may convert data associated with the received voice input to text data. According to an embodiment, the intelligent server 200 may generate at least one plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system. According to an embodiment, the plan may be selected from a set of predefined plans or may be generated in real time in response to a user's request. For example, the AI system may select at least one plan of the plurality of predefined plans.

According to an embodiment, the intelligent server 200 may transmit a result according to the generated plan to the electronic device 101 or may transmit the generated plan to the electronic device 101. According to an embodiment, the electronic device 101 may display the result according to the plan, on the display module 160. According to an embodiment, the electronic device 101 may display a result of executing the action according to the plan, on the display module 160.

The intelligent server 200 according to an embodiment may include a front end 210, a natural language platform 220, a capsule database 230, an execution engine 240, an end user interface 250, a management platform 260, a big data platform 270, or an analytic platform 280.

The front end 210 according to an embodiment may receive a voice input received by the electronic device 101 from the electronic device 101. The front end 210 may transmit a response corresponding to the voice input to the electronic device 101.

According to an embodiment, the natural language platform 220 may include an automatic speech recognition (ASR) module 221, a natural language understanding (NLU) module 223, a planner module 225, a natural language generator (NLG) module 227, and/or a text to speech module (TTS) module 229.

According to an embodiment, the ASR module 221 may convert the voice input received from the electronic device 101 into text data. According to an embodiment, the NLU module 223 may grasp the intent of the user by using the text data of the voice input. For example, the NLU module 223 may grasp the intent of the user by performing syntactic analysis and/or semantic analysis. According to an embodiment, the NLU module 223 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 225 may generate the plan by using a parameter and the intent that is determined by the NLU module 223. According to an embodiment, the planner module 225 may determine a plurality of domains necessary to perform a task, based on the determined intent. The planner module 225 may determine a plurality of actions included in each of the plurality of domains determined based on the intent. According to an embodiment, the planner module 225 may determine the parameter necessary to perform the determined plurality of actions or a result value output by the execution of the plurality of actions. The parameter and the result value may be defined as a concept of a specified form (or class). As such, the plan may include the plurality of actions and/or a plurality of concepts, which are determined by the intent of the user. The planner module 225 may determine the relationship between the plurality of actions and the plurality of concepts stepwise (or hierarchically). For example, the planner module 225 may determine the execution sequence of the plurality of actions, which are determined based on the user's intent, based on the plurality of concepts. In other words, the planner module 225 may determine an execution sequence of the plurality of actions, based on the parameters necessary to perform the plurality of actions and the result output by the execution of the plurality of actions. Accordingly, the planner module 225 may generate a plan including information (e.g., ontology) about the relationship between the plurality of actions and the plurality of concepts. The planner module 225 may generate the plan by using information stored in the capsule DB 230 storing a set of relationships between concepts and actions.

According to an embodiment, the NLG module 227 may change specified information into information in a text form. The information changed to the text form may be in the form of a natural language speech. The TTS module 229 according to an embodiment may change information in the text form to information in a voice form.

According to an embodiment, all or part of the functions of the natural language platform 220 may be also implemented in the electronic device 101. For example, the electronic device 101 may include an ASR module and/or an NLU module. The electronic device 101 may recognize the user's voice command and then may transmit text information corresponding to the recognized voice command to the intelligent server 200. For example, the electronic device 101 may include a TTS module. The electronic device 101 may receive text information from the intelligent server 200 and may output the received text information by using voice.

The capsule DB 230 may store information about the relationship between the actions and the plurality of concepts corresponding to a plurality of domains. According to an embodiment, the capsule may include a plurality of action objects (or action information) and/or concept objects (or concept information) included in the plan. According to an embodiment, the capsule DB 230 may store the plurality of capsules in a form of a concept action network (CAN). According to an embodiment, the plurality of capsules may be stored in the function registry included in the capsule DB 230.

The capsule DB 230 may include a strategy registry that stores strategy information necessary to determine a plan corresponding to a voice input. When there are a plurality of plans corresponding to the voice input, the strategy information may include reference information for determining one plan. According to an embodiment, the capsule DB 230 may include a follow-up registry that stores information of the follow-up action for suggesting a follow-up action to the user in a specified context. For example, the follow-up action may include a follow-up utterance. According to an embodiment, the capsule DB 230 may include a layout registry for storing layout information of the information output through the electronic device 101. According to an embodiment, the capsule DB 230 may include a vocabulary registry storing vocabulary information included in capsule information. According to an embodiment, the capsule DB 230 may include a dialog registry storing information about dialog (or interaction) with the user. The capsule DB 230 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. According to an embodiment, the capsule DB 230 may be implemented in the electronic device 101.

According to an embodiment, the execution engine 240 may calculate a result by using the generated plan. The end user interface 250 may transmit the calculated result to the electronic device 101. Accordingly, the electronic device 101 may receive the result and may provide the user with the received result. According to an embodiment, the management platform 260 may manage information used by the intelligent server 200. According to an embodiment, the big data platform 270 may collect data of the user. According to an embodiment, the analytic platform 280 may manage quality of service (QoS) of the intelligent server 200. For example, the analytic platform 280 may manage the component and processing speed (or efficiency) of the intelligent server 200.

According to an embodiment, the service server 300 may provide the electronic device 101 with a specified service (e.g., ordering food or booking a hotel). According to an embodiment, the service server 300 may be a server operated by the third party. According to an embodiment, the service server 300 may provide the intelligent server 200 with information for generating a plan corresponding to the received voice input. The provided information may be stored in the capsule DB 230. Furthermore, the service server 300 may provide the intelligent server 200 with result information according to the plan. The service server 300 may communicate with the intelligent server 200 and/or the electronic device 101 over the network 197. The service server 300 may communicate with the intelligent server 200 through a separate connection. An example is illustrated in FIG. 1 that the service server 300 is one server, but embodiments of the disclosure are not limited thereto. At least one of the respective services 301, 302, and 303 of the service server 300 may be implemented with a separate server.

In the above-described integrated intelligence system, the electronic device 101 may provide the user with various intelligent services in response to a user input. The user input may include, for example, an input through a physical button, a touch input, or a voice input.

According to an embodiment, the electronic device 101 may provide a speech recognition service via an intelligent app (or a speech recognition app) stored therein. In this case, for example, the electronic device 101 may recognize a user utterance or a voice input, which is received via the input module 150, and may provide the user with a service corresponding to the recognized voice input.

According to an embodiment, the electronic device 101 may perform a specified action, based on the received voice input, independently, or together with the intelligent server 200 and/or the service server 300. For example, the electronic device 101 may launch an app corresponding to the received voice input and may perform the specified action via the executed app.

According to an embodiment, when providing a service together with the intelligent server 200 and/or the service server 300, the electronic device 101 may detect a user utterance by using the input module 150 and may generate a signal (or voice data) corresponding to the detected user utterance. The electronic device 101 may transmit the voice data to the intelligent server 200 by using the communication module 190.

According to an embodiment, the intelligent server 200 may generate a plan for performing a task corresponding to the voice input or the result of performing an action depending on the plan, as a response to the voice input received from the electronic device 101. For example, the plan may include a plurality of actions for performing the task corresponding to the voice input of the user and/or a plurality of concepts associated with the plurality of actions. The concept may define a parameter to be entered upon executing the plurality of actions or a result value output by the execution of the plurality of actions. The plan may include relationship information between the plurality of actions and the plurality of concepts.

According to an embodiment, the electronic device 101 may receive the response by using the communication module 190. The electronic device 101 may output the voice signal generated in the electronic device 101 to the outside by using the sound output module 155 or may output an image generated in the electronic device 101 to the outside by using the display module 160.

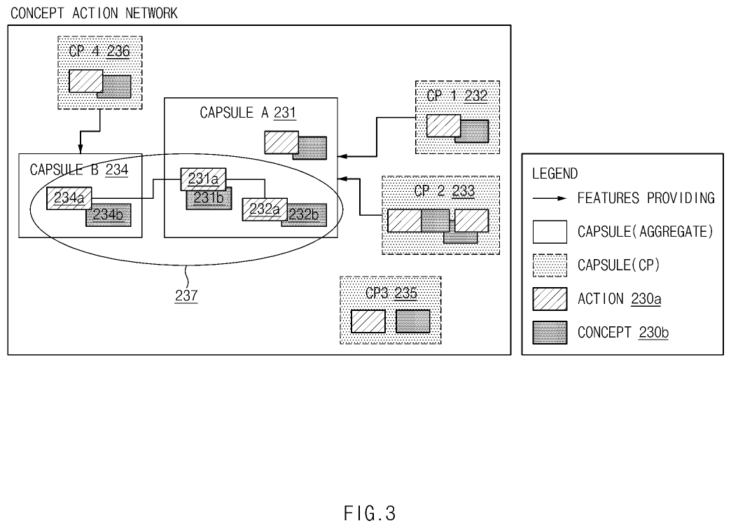

FIG. 3 is a diagram illustrating a form in which relationship information between a concept and an action is stored in a database, according to an embodiment.

A capsule database (e.g., the capsule DB 230) of the intelligent server 200 may store a capsule in the form of a concept action network (CAN). The capsule DB may store an action for processing a task corresponding to a user's voice input and a parameter necessary for the action, in the CAN form.

The capsule DB may store a plurality capsules (a capsule A 231 and a capsule B 234) respectively corresponding to a plurality of domains (e.g., applications). According to an embodiment, a single capsule (e.g., the capsule A 231) may correspond to a single domain (e.g., a location (geo) or an application). In addition, one capsule may correspond to a capsule (e.g., CP 1 232, CP 2 233, CP 3 235, and/or CP 4 236) of at least one service provider for performing a function for a domain associated with a capsule. According to an embodiment, the one capsule may include at least one or more actions 230a and at least one or more concepts 230b for performing a specified function.

The natural language platform 220 may generate a plan for performing a task corresponding to the received voice input by using the capsule stored in the capsule DB 230. For example, the planner module 225 of the natural language platform may generate the plan by using the capsule stored in the capsule database. For example, a plan 237 may be generated by using actions 231a and 232a and concepts 231b and 232b of the capsule A 231 and an action 234a and a concept 234b of the capsule B 234.

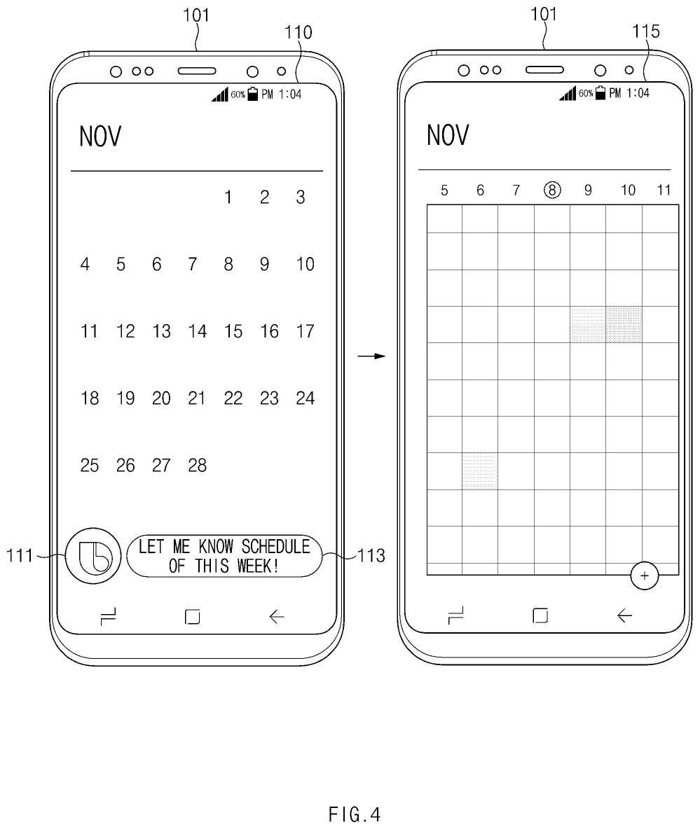

FIG. 4 is a view illustrating a screen in which a user terminal processes a voice input received through an intelligent app, according to an embodiment.

The electronic device 101 may launch an intelligent app to process a user input through the intelligent server 200.

According to an embodiment, on first screen 110, when recognizing a specified voice input (e.g., wake up!) or receiving an input via a hardware key (e.g., a dedicated hardware key), the electronic device 101 may launch an intelligent app for processing a voice input. For example, the electronic device 101 may launch the intelligent app in a state where a schedule app is executed. According to an embodiment, the electronic device 101 may display an object (e.g., an icon) 111 corresponding to the intelligent app, on the display module 160. According to an embodiment, the electronic device 101 may receive a voice input by a user utterance. For example, the electronic device 101 may receive a voice input saying that “let me know the schedule of this week!”. According to an embodiment, the electronic device 101 may display a user interface (UI) 113 (e.g., an input window) of the intelligent app, in which text data of the received voice input is displayed, on the display module 160.

According to an embodiment, on second screen 115, the electronic device 101 may display a result corresponding to the received voice input, on the display. For example, the electronic device 101 may receive a plan corresponding to the received user input and may display ‘the schedule of this week’ on the display depending on the plan.

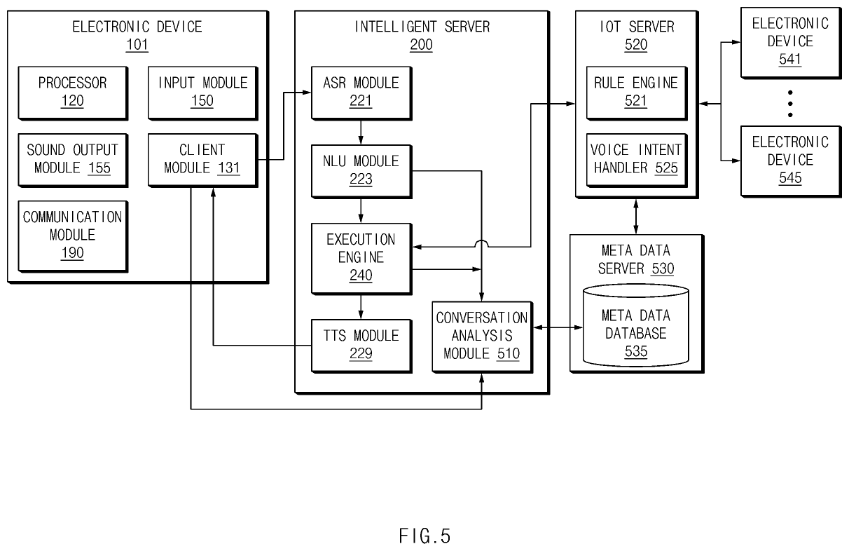

FIG. 5 illustrates a voice recognition service environment of the electronic device 101, according to an embodiment.

Referring to FIG. 5, the electronic device 101 may include the processor 120, the input module 150, the sound output module 155, the communication module 190, the client module 131, or a combination thereof.

The processor 120 may provide a voice recognition service for a user's utterance by executing the client module 131. Hereinafter, it is described that the processor 120 executes instructions of the client module 131 and thus the electronic device 101 provides the voice recognition service.

The client module 131 may obtain a natural language input. The natural language input may include a text input and/or a voice input. For example, the client module 131 may receive a voice input (or a voice signal) through the input module 150.

The client module 131 may determine the start of a conversation based on an event that the natural language input is obtained. The client module 131 may determine the start of the conversation based on an event that the specified natural language input (e.g., a wakeup utterance) is obtained. The client module 131 may determine the end of the conversation based on an event that the natural language input is not obtained during a specified time. The client module 131 may determine the end of the conversation based on an event that the natural language input for requesting the end of a conversation session is obtained. In an embodiment, an interval from the beginning of the conversation to the end of the conversation may be referred to as a “voice session”.

The client module 131 may transmit a voice input to the intelligent server 200 by using the communication module 190. The client module 131 may receive a result corresponding to the voice input from the intelligent server 200 by using the communication module 190.

The client module 131 may notify the intelligent server 200 of the start of the conversation by using the communication module 190. The client module 131 may notify the intelligent server 200 of the end of the conversation by using the communication module 190.

The client module 131 may provide the user with information indicating a result. For example, the client module 131 may provide the user with the information indicating the result by using the sound output module 155 (or the display module 160).

The intelligent server 200 may include the ASR module 221, the NLU module 223, the execution engine 240, the TTS module 229, a conversation analysis module 510, or a combination thereof.

The ASR module 221 may convert the voice input received from the electronic device 101 into text data.

The NLU module 223 may identify the user's intent by using the text data of the voice input.

The execution engine 240 may calculate the result by executing a task according to the user's intent. For example, when the user's intent corresponds to the control of electronic devices 541 and 545, the execution engine 240 may transmit a command for controlling the electronic devices 541 and 545 to an Internet of things (IoT) server 520. As another example, when the user's intent corresponds to the check of a current time, the execution engine 240 may execute an instruction for identifying a current time. Hereinafter, unless otherwise specified, each of the electronic devices 541 and 545 may be referred to as an “IoT device”.

The execution engine 240 may provide the electronic device 101 with feedback according to a voice input. For example, the execution engine 240 may generate information in a text form for feedback. The execution engine 240 may generate information in the text form indicating the calculated result. For example, when the user's intent corresponds to the control of the IoT device, the calculated result may be the control result of the IoT device. As another example, when the user's intent corresponds to the check of a current time, the calculated result may be the current time.

The TTS module 229 may change information in the text form to information in a voice form. The TTS module 229 may provide voice information to the electronic device 101.

The conversation analysis module 510 may receive a notification indicating the start of a conversation from the client module 131.

In an embodiment, the conversation analysis module 510 may receive a voice input and/or intent information from the NLU module 223. In another embodiment, the conversation analysis module 510 may receive voice input and/or intent information from the execution engine 240.

The conversation analysis module 510 may receive execution information from the execution engine 240. The execution information may include execution type information, identification information of an IoT device that performs a task according to a voice input, type information of the IoT device that performs the task, manufacturer information of the IoT device that performs the task, or a combination thereof. For example, the execution type may be divided into IoT device-based execution and other executions (e.g., acquisition of clock information, acquisition of weather information, and acquisition of driving information). The IoT device-based execution may indicate that a task according to intent is performed by an IoT device (e.g., the electronic devices 541 and 545) through the IoT server 520. The other executions may indicate that the task according to the intent is performed by the electronic device 101 and/or the intelligent server 200. The execution type may also be referred to as a “type of a domain” for performing a task according to an utterance.

In an embodiment, a voice input, intent information, and execution information may be received sequentially. For example, the conversation analysis module 510 may receive a first utterance among a plurality of utterances of a voice input, intent information about the first utterance, and execution information according to the first utterance and then may receive a second utterance thereof, intent information about the second utterance, and execution information according to the second utterance. Here, the second utterance may be an utterance following the first utterance.

In another embodiment, a voice input, intent information, and execution information may be received substantially at the same time. For example, the conversation analysis module 510 may substantially simultaneously receive a plurality of utterances of a voice input, intent information about each of the plurality of utterances, and execution information according to each of the plurality of utterances.

When a notification of a conversation start is received, the conversation analysis module 510 may generate a data set for generating a rule based on the voice input, the intent information, the execution information, or a combination thereof. In an embodiment, the rule may also be referred to as a “scene or routine”. In an embodiment, the rule may be used to control one or more IoT devices based on a plurality of commands through one trigger.

The conversation analysis module 510 may determine whether intent according to an utterance is device-related intent based on execution information obtained from the execution engine 240. For example, when the execution type of intent according to an utterance is IoT device-based execution (e.g., IoT), the conversation analysis module 510 may determine that the intent is the device-related intent. As another example, when the execution type of intent according to an utterance corresponds to execution (e.g., CLOCK) different from the IoT device-based execution (e.g., IoT), the conversation analysis module 510 may determine that the intent is not the device-related intent.

The conversation analysis module 510 may determine whether the intent according to the utterance is first intent. In an embodiment, the conversation analysis module 510 may determine whether the intent according to the utterance is the first intent related to the IoT device.

When the intent according to the utterance is the first intent related to the IoT device, the conversation analysis module 510 may obtain meta data. The conversation analysis module 510 may obtain meta data of an IoT device related to the intent according to the utterance from a meta data server 530. In an embodiment, the meta data may include type information, manufacturer information, specified device information (‘Friend Devices’), an intent list, specified intent information (‘Good to use with’), or a combination thereof.

The specified device may be an IoT device that is capable of being used (or recommended to be used) at the same time with an IoT device related to the intent according to the utterance. For example, when the IoT device related to the intent according to the utterance is an air conditioner, the specified device may be a fan.

The specified intent may be intent that is capable of being used (or recommended to be used) at the same time with the intent according to the utterance among pieces of intent of the IoT device related to the intent according to the utterance. For example, when the intent according to the utterance corresponds to turning on the air conditioner, the intent that is capable of being used (or recommended to be used) at the same time with the intent according to the utterance may be the adjustment of the air conditioner's temperature and/or the change of a mode.

The conversation analysis module 510 may add device-related information to a candidate list. The candidate list may include device-related information about an IoT device. The device-related information about the IoT device may include identification information of the IoT device, manufacturer information of the IoT device, the type of the IoT device, intent, and/or information about an utterance. The candidate list may be used as a data set for generating a rule.

Afterward, the conversation analysis module 510 may determine whether the intent according to a follow-up utterance (e.g., a second utterance) is device-related intent.

When the intent according to the follow-up utterance is device-related intent, the conversation analysis module 510 may determine whether device-related information about an IoT device related to intent according to a follow-up utterance is included in the candidate list.

When the device-related information about the IoT device related to the intent according to the follow-up utterance is included in the candidate list, the conversation analysis module 510 may determine whether the intent according to the follow-up utterance is the specified intent.

For example, when the meta data included in a meta data list includes intent according to the follow-up utterance, the conversation analysis module 510 may determine that the intent according to the follow-up utterance is specified intent. As another example, when pieces of intent indicated by the intent specified by pieces of intent according to a preceding utterance include intent according to a follow-up utterance, the conversation analysis module 510 may determine that the intent according to the utterance is the specified intent.

When the intent of the IoT device in which device-related information is included in a candidate list is the specified intent, the conversation analysis module 510 may add the device-related information related to intent according to the follow-up utterance to the candidate list. When the intent of the IoT device in which device-related information is included in the candidate list is the specified intent, the conversation analysis module 510 may add information of the follow-up utterance and intent information according to the follow-up utterance to the candidate list. The conversation analysis module 510 may store information of a follow-up utterance and intent information according to the follow-up utterance in association with device-related information related to intent according to the follow-up utterance of the candidate list.

When device-related information about an IoT device related to the intent according to the follow-up utterance is not included in the candidate list, the conversation analysis module 510 may determine whether an IoT device related to the intent according to the follow-up utterance is a specified device.

For example, when an IoT device according to an utterance is included in specified devices indicated by the pre-stored meta data, the conversation analysis module 510 may determine that the IoT device according to the utterance is the specified device.

When the IoT device related to the intent according to the follow-up utterance is the specified device, the conversation analysis module 510 may add device-related information related to the intent according to the follow-up utterance to the candidate list. Moreover, when the IoT device related to the intent according to the follow-up utterance is the specified device, the conversation analysis module 510 may obtain meta data of the IoT device related to the intent according to the follow-up utterance from the meta data server 530.

Until a notification of the end of the conversation is received, the conversation analysis module 510 may update the candidate list according to an utterance and/or may obtain meta data.

When the notification of the end of the conversation is received, the conversation analysis module 510 may determine whether to generate a rule. The conversation analysis module 510 may inquire of the electronic device 101 whether to generate a rule and may determine whether to generate a rule based on a response from the electronic device 101.

When the electronic device 101 agrees to rule generation, the conversation analysis module 510 may request the IoT server 520 to generate a rule. In an embodiment, a request for rule generation may include a data set indicating a candidate list.

The IoT server 520 may include a rule engine 521 and/or a voice intent handler 525.

The rule engine 521 may execute a rule based on a specified condition and/or user's request. The user's request may be based on the intent identified depending on the voice input and/or touch input of the electronic device 101.

The rule engine 521 may control operations of a plurality of IoT devices (e.g., the electronic device 541 and 545) based on at least one rule.

The rule engine 521 may receive a rule generation request from the conversation analysis module 510. The rule generation request may include a data set for rule generation.

The rule engine 521 may generate a rule based on the rule generation request. The rule engine 521 may generate a rule by using the data set.

The voice intent handler 525 may identify an IoT device to be controlled among a plurality of IoT devices based on intent identified by a voice input (and/or touch input) and may control the identified IoT device based on the intent.

The meta data server 530 may include a meta data database 535.

Meta data of each of the IoT devices may be stored in the meta data database 535.

The meta data may include information about each of the IoT devices. The information about each of the IoT devices may include identification information, type information, manufacturer information, a support function, the definition of intent, related IoT device information, related intent information, or a combination thereof.

The meta data may be provided by a manufacturer of each of the IoT devices. Default information may be applied to information, which is not provided by a manufacturer, from among information included in the meta data of any IoT device. In an embodiment, the default information may be information obtained from meta data included in another IoT device having the same type as the type of any IoT device. In another embodiment, the default information may be a default value entered by an operator of the meta data server 530.

According to another embodiment, the electronic device 101 may include at least some of the functional components of the intelligent server 200. For example, the electronic device 101 may include the ASR module 221, the NLU module 223, the execution engine 240, the TTS module 229, the conversation analysis module 510 of the intelligent server 200, or a combination thereof.

In another embodiment, at least two servers among the intelligent server 200, the IoT server 520, and the meta data server 530 may be implemented as one integrated server. For example, the intelligent server 200 and the meta data server 530 may be implemented as one server. As another example, the intelligent server 200 and the IoT server 520 may be implemented as one server. As still another example, the intelligent server 200, the IoT server 520, and the meta data server 530 may be implemented as one server.

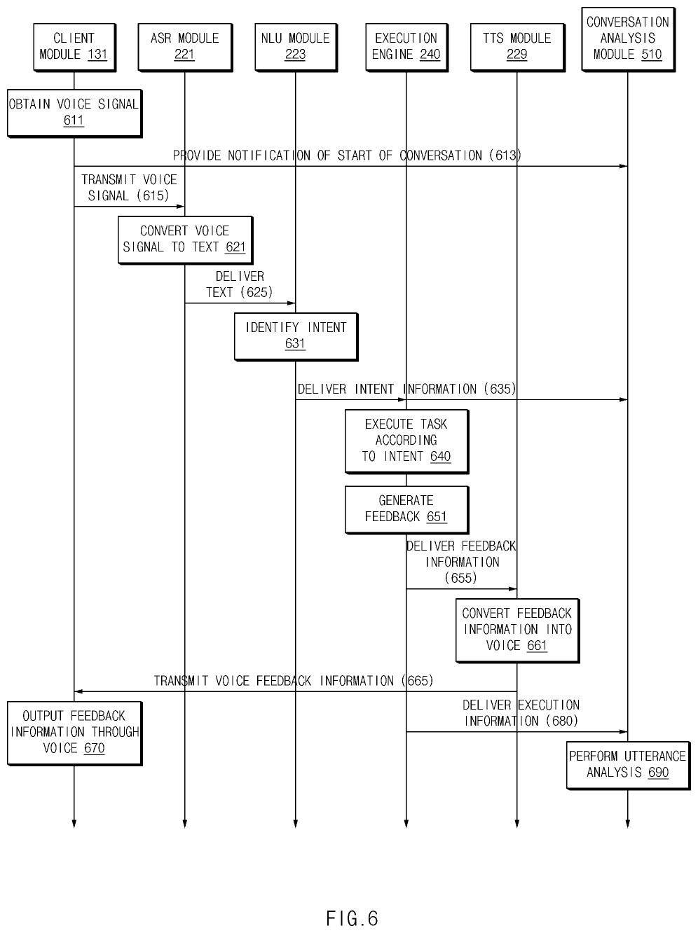

FIG. 6 is a flowchart illustrating an operation of the electronic device 101, according to an embodiment.

Referring to FIG. 6, in operation 611, the client module 131 of the electronic device 101 may obtain a voice signal. The client module 131 may obtain the voice signal through the input module 150.

In operation 613, the client module 131 may inform the conversation analysis module 510 to start a conversation. The client module 131 may determine the start of the conversation based on an event that the specified natural language input (e.g., a wakeup utterance) is obtained. The client module 131 may inform the conversation analysis module 510 of the start of a conversation by using the communication module 190.

In operation 615, the client module 131 may transmit the voice signal to the ASR module 221. The client module 131 may transmit the voice signal to the ASR module 221 by using the communication module 190.

In operation 621, the ASR module 221 may convert a voice signal to a text. The ASR module 221 may convert the voice signal received from the electronic device 101 into the text. An operation of the ASR module 221 may be described through the description of the ASR module 221 of FIG. 2.

In operation 625, the ASR module 221 may deliver the converted text to the NLU module 223.

In operation 631, the NLU module 223 may identify intent based on the text. An operation of the NLU module 223 may be described through the description of the NLU module 223 of FIG. 2.

In operation 635, the NLU module 223 may deliver intent information to the execution engine 240 and the conversation analysis module 510.

The NLU module 223 may transmit utterance information together with the intent information to the execution engine 240 and the conversation analysis module 510.

In operation 640, the execution engine 240 may execute a task according to the intent. An operation of the execution engine 240 may be described through the description of the execution engine 240 of FIG. 2.

In operation 651, the execution engine 240 may generate feedback indicating the execution result of the task.

In operation 655, the execution engine 240 may deliver feedback information to the TTS module 229.

In operation 661, the TTS module 229 may convert the feedback information into a voice.

In operation 665, the TTS module 229 may transmit the voice feedback information to the client module 131.

In operation 670, the client module 131 may output the feedback information through a voice. The client module 131 may output feedback on the response processing result (or execution result) according to the received voice signal of a user through the display module 160.

In operation 680, the execution engine 240 may deliver execution information to the conversation analysis module 510.

The execution engine 240 may deliver intent information and/or utterance information together with the execution information to the conversation analysis module 510.

In operation 690, the conversation analysis module 510 may perform utterance analysis. The conversation analysis module 510 may perform the utterance analysis based on the intent information, the execution information, and the voice signal.

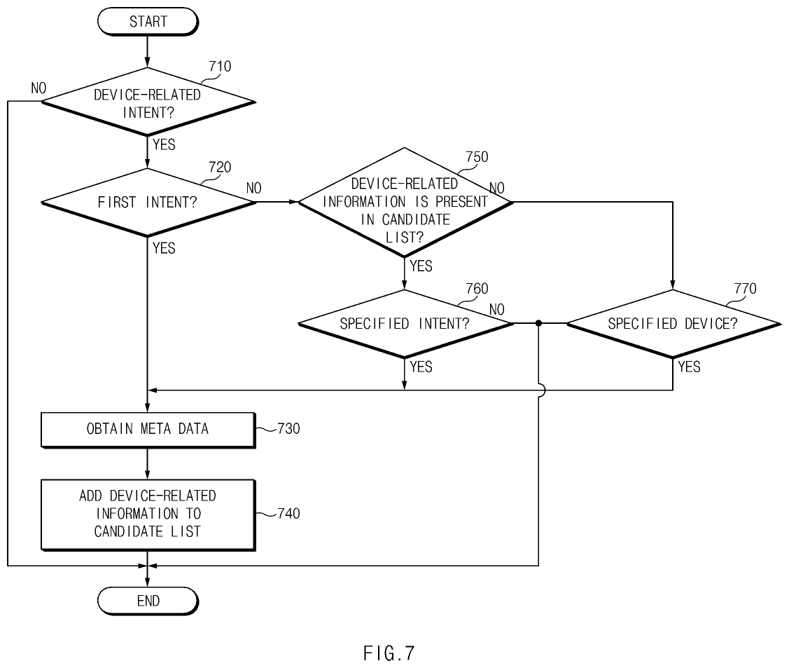

Operation 690 may be described in detail with reference to FIGS. 7, 8A, 9, 10A, and 11A below.

The operations of FIG. 6 may be performed whenever the client module 131 obtains/receives a voice signal. In an embodiment, operation 613 among the operations of FIG. 6 may be performed once during a voice session. For example, operation 613 may be performed once when a voice signal is first obtained.

Hereinafter, it is described that the execution engine 240 delivers the intent information and/or the utterance information together with the execution information to the conversation analysis module 510. Accordingly, it may be understood that the meaning of the execution engine 240 delivering the execution information to the conversation analysis module 510 corresponds to the execution engine 240 delivering the intent information and/or the utterance information together with the execution information to the conversation analysis module 510.

FIG. 7 is a flowchart illustrating an operation of the intelligent server 200, according to an embodiment.

Operations of FIG. 7 may be included in operation 690. The operations of FIG. 7 may be performed by the conversation analysis module 510.

Referring to FIG. 7, in operation 710, the conversation analysis module 510 may determine whether intent is device-related intent. The conversation analysis module 510 may determine whether intent according to an utterance is device-related intent based on execution information obtained from the execution engine 240.

For example, when the execution type of intent according to an utterance is IoT device-based execution (e.g., IoT), the conversation analysis module 510 may determine that the intent is device-related intent. As another example, when the execution type of intent according to an utterance corresponds to execution (e.g., CLOCK) different from the IoT device-based execution (e.g., IoT), the conversation analysis module 510 may determine that the intent is not the device-related intent. Other examples are also possible in other embodiments.

When it is determined in operation 710 that the intent is the device-related intent, the conversation analysis module 510 may perform operation 720. When it is determined in operation 710 that the intent is not the device-related intent, the conversation analysis module 510 may end the operation according to FIG. 7.

In operation 720, the conversation analysis module 510 may determine whether the intent is first intent. In an embodiment, the conversation analysis module 510 may determine whether the intent according to the utterance is the first intent related to the IoT device.

When it is determined in operation 720 that the intent is the first intent, the conversation analysis module 510 may perform operation 730. When it is determined in operation 720 that the intent is not the first intent, the conversation analysis module 510 may perform operation 750.

In operation 730, the conversation analysis module 510 may obtain meta data. The conversation analysis module 510 may obtain meta data of an IoT device related to the intent according to the utterance from the meta data server 530. In an embodiment, the meta data may include type information, manufacturer information, specified device information (e.g., ‘Friend Devices’), an intent list, specified intent information (e.g., ‘Good to use with’), or a combination thereof.

In operation 740, the conversation analysis module 510 may add device-related information to a candidate list. The candidate list may include device-related information about an IoT device. The device-related information about the IoT device may include identification information of the IoT device, manufacturer information of the IoT device, the type of the IoT device, intent, and information about an utterance. The candidate list may be used as a data set for generating a rule.

In operation 750, the conversation analysis module 510 may determine whether device-related information about the IoT device is included in the candidate list. In an embodiment, the conversation analysis module 510 may determine whether device-related information about the IoT device is included in the candidate list, based on identification information of the IoT device.

When it is determined in operation 750 that the device-related information about the IoT device is included in the candidate list, the conversation analysis module 510 may perform operation 760. When it is determined in operation 750 that the device-related information about the IoT device is not included in the candidate list, the conversation analysis module 510 may perform operation 770.

In operation 760, the conversation analysis module 510 may determine whether the intent is specified intent. In an embodiment, the conversation analysis module 510 may determine whether the intent is the specified intent, based on the meta data. For example, the conversation analysis module 510 may determine whether the intent according to an utterance is the specified intent, based on whether the pre-stored meta data indicates the intent according to the utterance.

When it is determined in operation 760 that the intent is the specified intent, the conversation analysis module 510 may perform operation 730.

When it is determined in operation 760 that the intent is not the specified intent, the conversation analysis module 510 may end the operation according to FIG. 7.

In operation 770, the conversation analysis module 510 may determine whether the device is a specified device. For example, the conversation analysis module 510 may determine whether the IoT device according to the utterance is a specified device, based on whether the meta data included in the meta data list indicates the IoT device according to the utterance. In an embodiment, when the meta data included in the meta data list indicates the IoT device (or the type of an IoT device) according to the utterance, the conversation analysis module 510 may determine that the IoT device according to the utterance is the specified device.

When it is determined in operation 770 that the IoT device is the specified device, the conversation analysis module 510 may perform operation 730. When it is determined in operation 770 that the IoT device is not the specified device, the conversation analysis module 510 may end the operation according to FIG. 7.

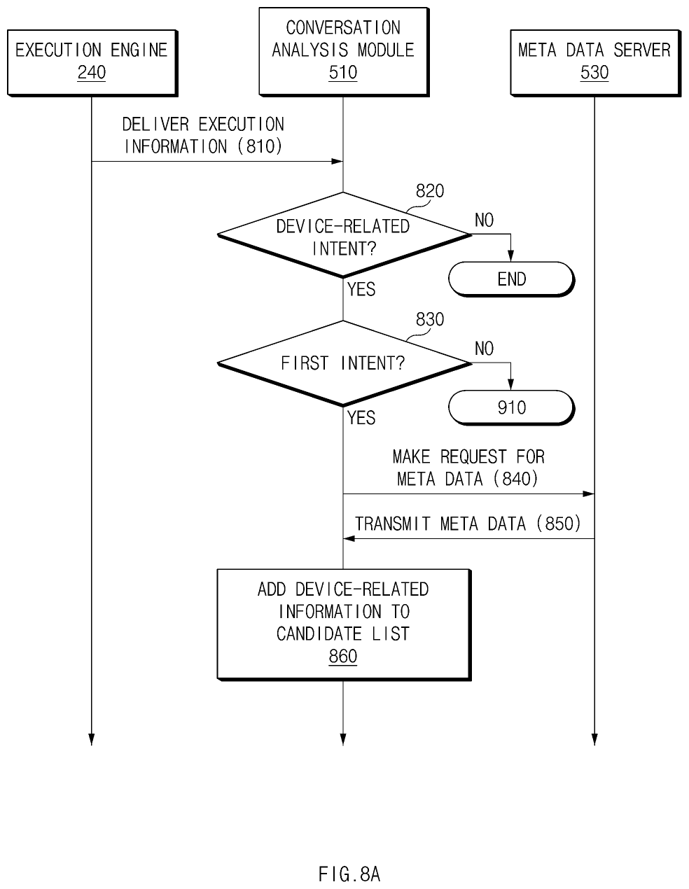

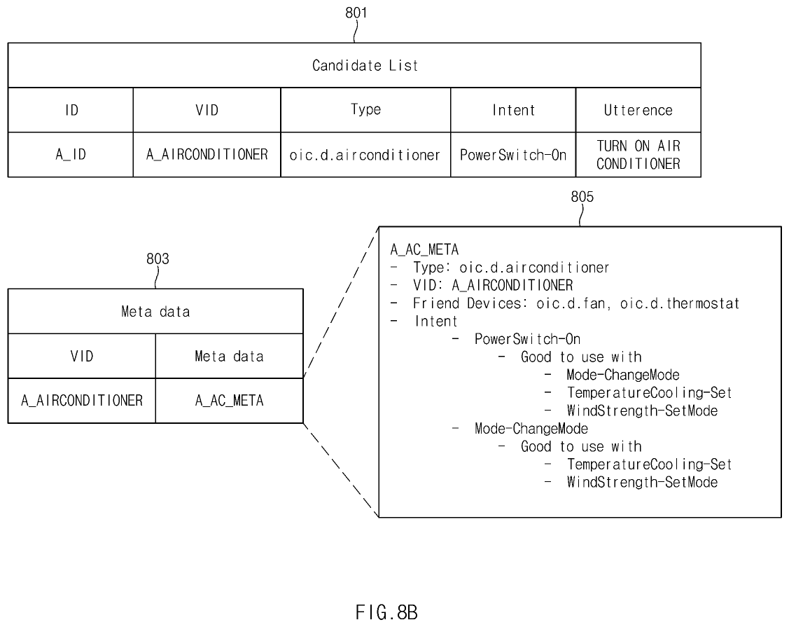

Hereinafter, an operation of performing utterance analysis depending on a voice input will be described with reference to FIGS. 8A, 8B, 9, 10A, 10B, 11A, and 11B. The voice input may include a plurality of utterances. Examples of the plurality of utterances are “what time is it now”, “turn on an air conditioner”, “set the temperature of an air conditioner to 25 degrees”, “turn off a fan”, and “mute a speaker”. Several other utterances are possible.

FIG. 8A is a flowchart illustrating an operation of the intelligent server 200, according to an embodiment.

Operation 810 of FIG. 8A may correspond to operation 680 of FIG. 6.

Operation 820, operation 830, operation 840, operation 850, and operation 860 of FIG. 8A may correspond to the operations of FIG. 7.

Referring to FIG. 8A, in operation 810, the execution engine 240 may deliver execution information to the conversation analysis module 510. It may be understood that, in operation 810, the execution engine 240 delivers intent information and/or utterance information together with the execution information to the conversation analysis module 510.

For example, the execution engine 240 may deliver, to the conversation analysis module 510, the execution information according to “what time is it now”, “turn on an air conditioner”, “set the temperature of an air conditioner to 25 degrees”, “turn off a fan”, and “mute a speaker”. In an embodiment, the execution engine 240 may sequentially deliver the execution information according to each utterance to the conversation analysis module 510. In another embodiment, the execution engine 240 may simultaneously deliver the execution information according to each utterance to the conversation analysis module 510.

The execution information according to “what time is it now”, “turn on an air conditioner”, “set the temperature of an air conditioner to 25 degrees”, “turn off a fan”, and “mute a speaker” may be summarized as in Table 1 below.

TABLE 1

| | Execution | | Identification | Type | Manufacturer |
|---|---|---|---|---|---|
| Utterance | type | Intent | information | information | information |
| What time | CLOCK | CurrentTime-Get | | | |
| is it now | | | | | |
| Turn on air | IoT | PowerSwitch-On | A_ID | oic.d.airconditioner | A_AIRCONDITIONER |
| conditioner | | | | | |
| Set temperature | IoT | TemperatureCooling-Set | A_ID | oic.d.airconditioner | A_AIRCONDITIONER |
| of air | | | | | |
| conditioner | | | | | |
| to 25 degrees | | | | | |
| Turn off fan | IoT | PowerSwitch-Off | B_ID | oic.d.fan | A_FAN |
| Mute speaker | IoT | Volume-Mute-On | C_ID | oic.d.speaker | A_SPEAKER |

In operation 820, the conversation analysis module 510 may determine whether the intent is device-related intent. The conversation analysis module 510 may determine whether the intent is the device-related intent, based on the execution information.

For example, when execution type information of the execution information indicates IoT device-based execution (e.g., IoT), the conversation analysis module 510 may determine that the intent is the device-related intent. As another example, when the execution type information of the execution information indicates other executions (e.g., CLOCK), the conversation analysis module 510 may determine that the intent is not the device-related intent.

For example, it may be determined that intent of “what time is it now” is not the device-related intent. As another example, it may be determined that intent of each of “turn on an air conditioner”, “set the temperature of an air conditioner to 25 degrees”, “turn off a fan”, or “mute a speaker” is the device-related intent.

When it is determined in operation 820 that the intent is the device-related intent, the conversation analysis module 510 may perform operation 830. When it is determined in operation 820 that the intent is not the device-related intent, the conversation analysis module 510 may end the operation according to FIG. 8A.

In operation 830, the conversation analysis module 510 may determine whether the intent is first intent. In an embodiment, the conversation analysis module 510 may determine whether the intent is the first intent related to the IoT device.

For example, the conversation analysis module 510 may determine that intent of “turn on an air conditioner” among pieces of intent of each of “turn on an air conditioner”, “set the temperature of an air conditioner to 25 degrees”, “turn off a fan”, or “mute a speaker” is the first intent related to the IoT device.

As another example, the conversation analysis module 510 may determine that intent of each of “set the temperature of an air conditioner to 25 degrees”, “turn off a fan”, or “mute a speaker” is not a first intent.

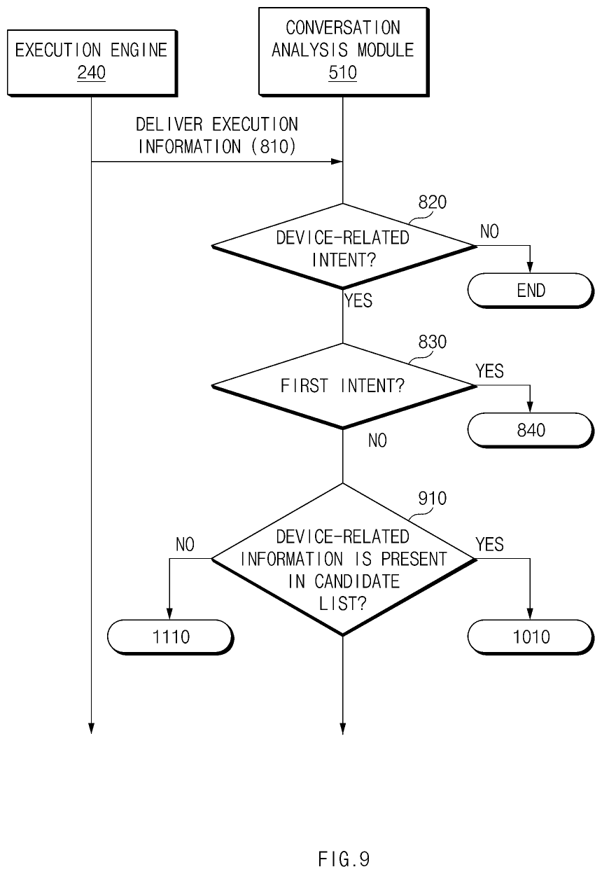

When it is determined in operation 830 that the intent is the first intent, the conversation analysis module 510 may perform operation 840. When it is determined in operation 830 that the intent is not the first intent, the conversation analysis module 510 may perform operation 910. Operation 910 may be described in the description of FIG. 9.

For example, the conversation analysis module 510 may perform operation 840 on “turn on an air conditioner”. As another example, the conversation analysis module 510 may perform operation 910 on each of “set the temperature of an air conditioner to 25 degrees”, “turn off a fan”, or “mute a speaker”.

In operation 840, the conversation analysis module 510 may make a request for meta data to the meta data server 530. In an embodiment, the request for the meta data may include identification information of an IoT device related to intent, type information of the IoT device, manufacturer information of the IoT device, or a combination thereof.

In operation 850, the meta data server 530 may transmit the meta data to the conversation analysis module 510.

In an embodiment, the conversation analysis module 510 may manage the meta data received from the meta data server 530 as a meta data list.

In an embodiment, the meta data list may include information (e.g., manufacturer information of an IoT device) for classifying IoT devices and meta data. The meta data may include type information, manufacturer information, specified device information (‘Friend Devices’), an intent list, specified intent information (‘Good to use with’), or a combination thereof.

In operation 860, the conversation analysis module 510 may add the device-related information to a candidate list.

The candidate list may include device-related information about an IoT device. The device-related information about the IoT device may include identification information of the IoT device, manufacturer information of the IoT device, the type of the IoT device, intent, and information about an utterance.

FIG. 8B illustrates a candidate list 801 and a meta data list 803. The candidate list 801 and the meta data list 803 may be data generated and/or updated depending on the operation of FIG. 8A.

FIG. 8B may show the candidate list 801 and the meta data list 803, which are generated and/or updated depending on pieces of intent of “what time is it now” and “turn on an air conditioner”.

The candidate list 801 may include device-related information about an air conditioner. The device-related information about an air conditioner may include identification information (A_ID) of the air conditioner, manufacturer information (A_AIRCONDITIONER) of the air conditioner, the type (oic.d.airconditioner) of the air conditioner, intent (PowerSwitch-On), and information about an utterance (“turn on an air conditioner”).

The meta data list 803 may include information (e.g., manufacturer information (A_AIRCONDITIONER) of an air conditioner) for classifying air conditioners and meta data (A_AC_META) 805. The meta data 805 may include type information, manufacturer information, specified device information (‘Friend Devices’), an intent list, specified intent information (‘Good to use with’), or a combination thereof.

FIG. 9 is a flowchart illustrating an operation of the intelligent server 200, according to an embodiment.

Operation 810 of FIG. 9 may correspond to operation 680 of FIG. 6.

Operation 820, operation 830, and operation 910 of FIG. 9 may correspond to the operations of FIG. 7.

Descriptions the same as those of operation 810, operation 820, and operation 830 in FIG. 8A are omitted to avoid redundancy.

Referring to FIG. 9, in operation 910, the conversation analysis module 510 may determine whether device-related information about the IoT device is included in the candidate list. In an embodiment, the conversation analysis module 510 may determine whether device-related information about the IoT device is included in the candidate list, based on identification information of the IoT device.

For example, the conversation analysis module 510 may determine that device-related information about the air conditioner is included in the candidate list (e.g., the candidate list 801 of FIG. 8B) based on the identification information (A_ID) of the air conditioner related to “set the temperature of an air conditioner to 25 degrees”. As another example, the conversation analysis module 510 may determine that device-related information about a fan is not included in the candidate list, based on identification information (B_ID) of the fan related to “turn off a fan”. As another example, the conversation analysis module 510 may determine that device-related information about a speaker is not included in the candidate list, based on identification information (C_ID) of the speaker related to “mute a speaker”.

When it is determined in operation 910 that the device-related information about the IoT device is included in the candidate list, the conversation analysis module 510 may perform operation 1010. When it is determined in operation 910 that device-related information about the IoT device is not included in the candidate list, the conversation analysis module 510 may perform operation 1110.

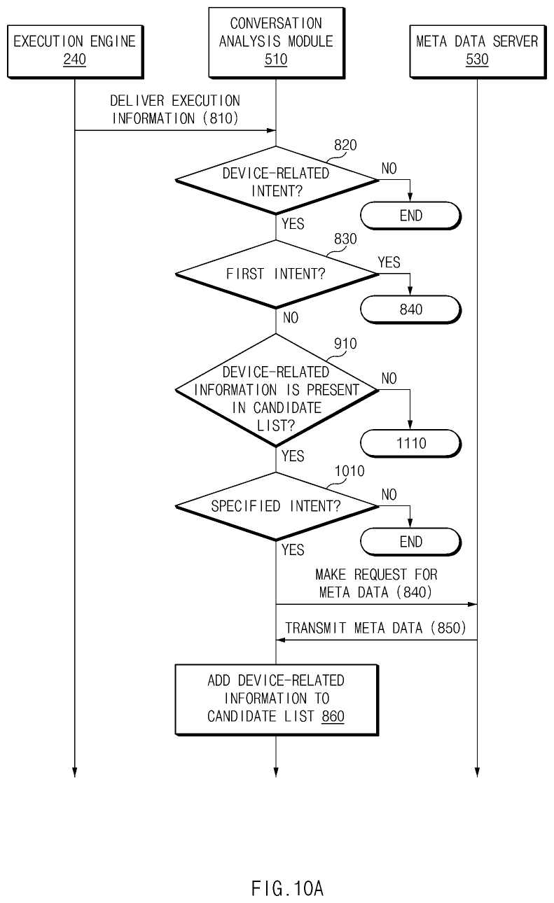

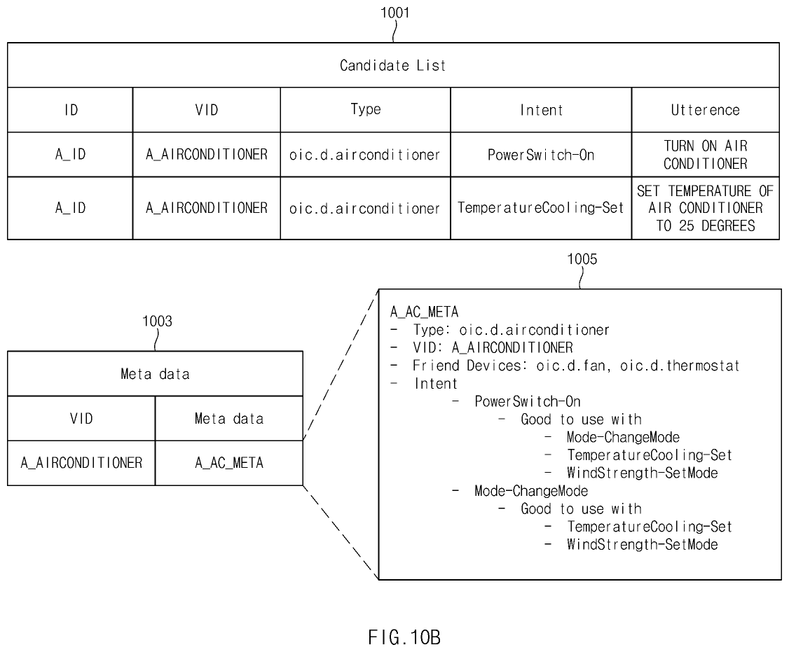

FIG. 10A is a flowchart illustrating an operation of the intelligent server 200, according to an embodiment.

Operation 810 of FIG. 10A may correspond to operation 680 of FIG. 6.

Operation 820, operation 830, and operation 910 of FIG. 10A may correspond to the operations of FIG. 7.

Descriptions the same as those of operation 810, operation 820, operation 830, operation 840, operation 850, and operation 910 in FIGS. 8A and 9 are omitted to avoid redundancy.

Referring to FIG. 10A, in operation 1010, the conversation analysis module 510 may determine whether intent is specified intent. The conversation analysis module 510 may determine whether intent according to an utterance is the specified intent.

In an embodiment, the conversation analysis module 510 may determine whether the intent is the specified intent, based on a meta data list.

For example, the conversation analysis module 510 may determine whether intent according to an utterance is the specified intent, based on whether meta data included in the meta data list indicates the intent according to the utterance.

In an embodiment, when the intent according to the utterance is included in the meta data included in the meta data list, the conversation analysis module 510 may determine that the intent according to the utterance is the specified intent. For example, because intent (TemperatureCooling-Set) of “set the temperature of an air conditioner to 25 degrees” is one of pieces of intent (PowerSwitch-On, Mode-ChangeMode, TemperatureCooling-Set, and WindStrength-SetMode) included in the meta data 805, the conversation analysis module 510 may determine that the intent (TemperatureCooling-Set) is the specified intent.

In an embodiment, when pieces of intents according to an utterance are included in pieces of intent indicated by a preceding utterance included in the meta data in the meta data list, the conversation analysis module 510 may determine that the intent according to the utterance is the specified intent. For example, because the intent (TemperatureCooling-Set) is included in the pieces of intent (Mode-ChangeMode, TemperatureCooling-Set, and WindStrength-SetMode) specified by intent (PowerSwitch-On) according to a preceding utterance (“turn on an air conditioner”) for “set the temperature of an air conditioner to 25 degrees”, the conversation analysis module 510 may determine that the intent (TemperatureCooling-Set) is the specified intent.

When it is determined in operation 1010 that the intent is the specified intent, the conversation analysis module 510 may perform operation 840. When it is determined in operation 1010 that the intent is not the specified intent, the conversation analysis module 510 may end the operation according to FIG. 10A.

In an embodiment, when the meta data to be requested to the meta data server 530 is already stored in the conversation analysis module 510, operation 840 and operation 850 may not be performed. For example, because the meta data 805 for an air conditioner is already stored in the conversation analysis module 510, the conversation analysis module 510 may not make a request for the meta data 805 for the air conditioner to the meta data server 530.

In operation 860, the conversation analysis module 510 may add device-related information to a candidate list. In an embodiment, the conversation analysis module 510 may add information about the added intent to the candidate list.

FIG. 10B illustrates a candidate list 1001 and a meta data list 1003. The candidate list 1001 and the meta data list 1003 may be data updated depending on the operation of FIG. 10A. The candidate list 1001 and the meta data list 1003 may be data updated from the candidate list 801 and the meta data list 803.

FIG. 10B may show the candidate list 1001 and the meta data list 1003, which are updated depending on intent of “set the temperature of an air conditioner to 25 degrees”.

The candidate list 1001 may include device-related information about an air conditioner. Compared to the candidate list 801, the candidate list 1001 may further include information about intent (TemperatureCooling-Set) and an utterance (“set the temperature of an air conditioner to 25 degrees”).

The meta data list 1003 may be the same as the meta data list 803 because no new meta data is added. Accordingly, meta data 1005 may be the same as the meta data 805.

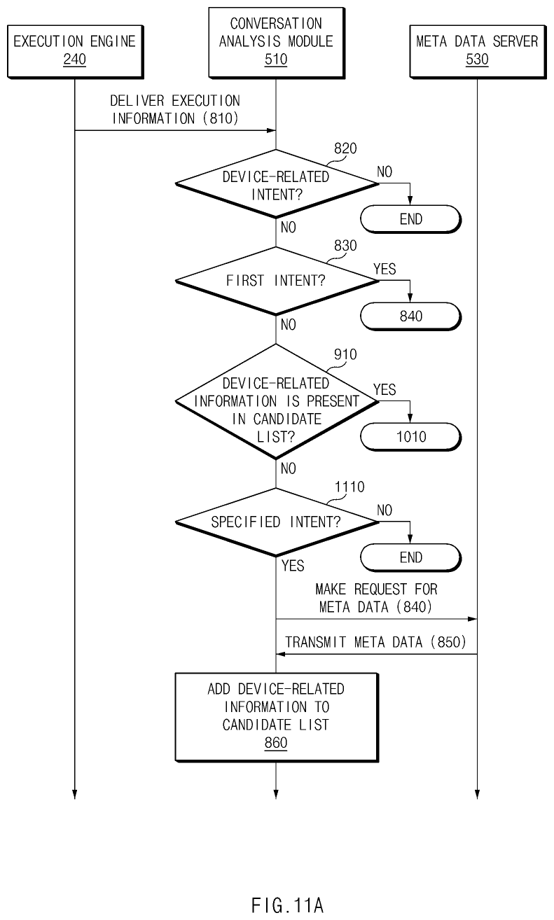

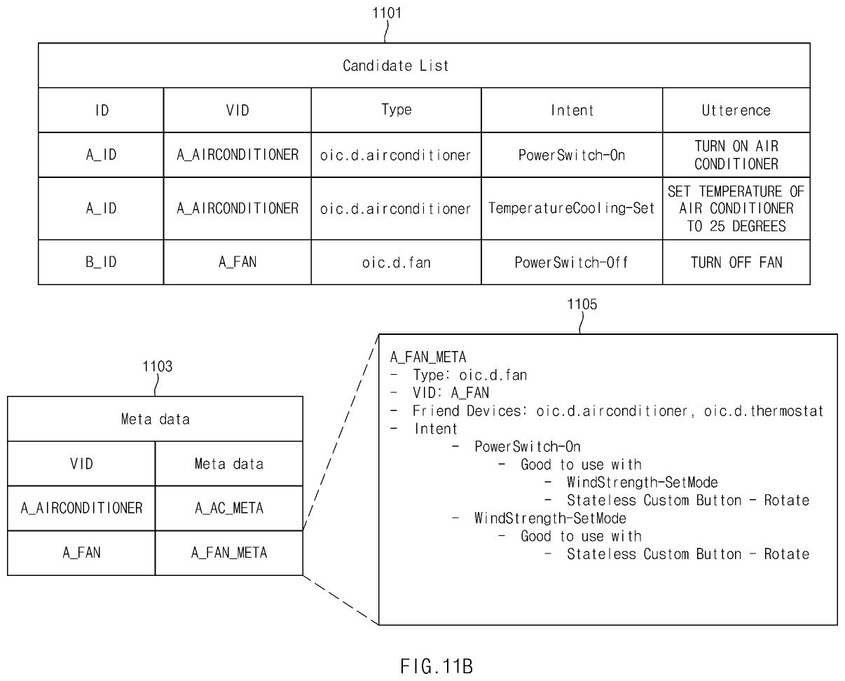

FIG. 11A is a flowchart illustrating an operation of the intelligent server 200, according to an embodiment.

Operation 810 of FIG. 11A may correspond to operation 680 of FIG. 6.

Operation 820, operation 830, and operation 910 of FIG. 11A may correspond to the operations of FIG. 7.

Descriptions the same as those of operation 810, operation 820, operation 830, operation 840, operation 850, and operation 910 in FIGS. 8A and 9 are omitted to avoid redundancy.

Referring to FIG. 11A, in operation 1110, the conversation analysis module 510 may determine whether an IoT device is a specified device.

For example, the conversation analysis module 510 may determine whether the IoT device according to the utterance is a specified device, based on whether the meta data included in the meta data list indicates the IoT device according to the utterance.

In an embodiment, when the meta data included in the meta data list indicates the IoT device (or the type of an IoT device) according to the utterance, the conversation analysis module 510 may determine that the IoT device according to the utterance is a specified device.

For example, because a type (oic.d.fan) of a fan for “turn off a fan” is one of types (oic.d.fan, oic.d.thermostat) indicated by the meta data 1005, the conversation analysis module 510 may determine that the fan for “turn off a fan” is a specified device.

As another example, because a type (oic.d.speaker) of a speaker for “mute a speaker” is not included in one of types (oic.d.fan, oic.d.thermostat) indicated by the meta data 1005, the conversation analysis module 510 may determine that the speaker for “mute a speaker” is not the specified device.

When it is determined in operation 1110 that the IoT device is the specified device, the conversation analysis module 510 may perform operation 840. When it is determined in operation 1110 that the IoT device is not the specified device, the conversation analysis module 510 may end the operation according to FIG. 11A.

For example, the conversation analysis module 510 may perform operation 840 in response to “turn off a fan”. As another example, the conversation analysis module 510 may end the operation according to FIG. 11A for “mute a speaker”.

In operation 840, the conversation analysis module 510 may make a request for meta data for a fan, which is an IoT device for “turn off a fan”, to the meta data server 530.

In operation 850, the meta data server 530 may transmit the meta data for the fan, which is an IoT device for “turn off a fan”, to the conversation analysis module 510.

In an embodiment, the conversation analysis module 510 may manage the meta data for the fan, which is an IoT device for “turn off a fan” received from the meta data server 530, as a meta data list.

In operation 860, the conversation analysis module 510 may add device-related information about the fan, which is an IoT device for “turn off a fan”, to the candidate list.

FIG. 11B illustrates a candidate list 1101 and a meta data list 1103. The candidate list 1101 and the meta data list 1103 may be data updated depending on the operation of FIG. 11A. The candidate list 1101 and the meta data list 1103 may be data updated from the candidate list 1001 and the meta data list 1003.

FIG. 11B may show the candidate list 1101 and the meta data list 1103 updated depending on “turn off a fan”.

The candidate list 1101 may include device-related information about a fan. The device-related information about the fan may include identification information (B_ID) of a fan, manufacturer information (A_FAN) of the fan, a fan type (oic.d.fan), intent (PowerSwitch-Off), and information about an utterance (“turn off a fan”).

The meta data list 1003 may include information (e.g., manufacturer information (A_FAN) of a fan) for classifying a fan and meta data (A_FAN_META) 1105. The meta data 1105 may include type information, manufacturer information, specified device information (‘Friend Devices’), an intent list, specified intent information (‘Good to use with’), or a combination thereof.

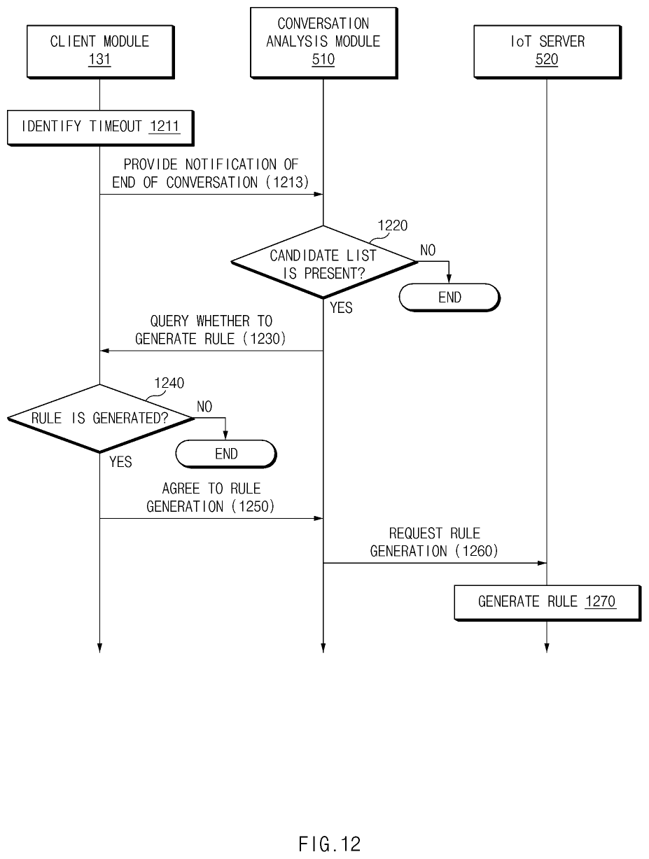

FIG. 12 is a flowchart illustrating an operation of the electronic device 101, according to an embodiment.

Referring to FIG. 12, in operation 1211, the client module 131 of the electronic device 101 may identify a timeout. The client module 131 may identify the timeout based on an event that a natural language input is not obtained during a specified time.

In operation 1213, the client module 131 may inform the conversation analysis module 510 to end a conversation. The client module 131 may notify the conversation analysis module 510 to end the conversation, based on identifying the timeout by using the communication module 190.

In operation 1220, the conversation analysis module 510 may determine whether a candidate list is present.

When it is determined in operation 1220 that the candidate list is present, the conversation analysis module 510 may perform operation 1230. When it is determined in operation 1220 that the candidate list is not present, the conversation analysis module 510 may end the operation according to FIG. 12.

In operation 1230, the conversation analysis module 510 may query the client module 131 whether to generate a rule. The query on whether to generate a rule may include information about related utterances. The related utterances may be utterances included in the candidate list. For example, the query on whether to generate a rule may include information about “turn on an air conditioner”, “set the temperature of an air conditioner to 25 degrees”, and “turn off a fan” among “what time is it now”, “turn on an air conditioner”, “set the temperature of an air conditioner to 25 degrees”, “turn off a fan”, and “mute a speaker”.

In operation 1240, the client module 131 may determine whether to generate a rule.

In an embodiment, the client module 131 may inquire of a user whether to generate a rule through the display module 160 (or the sound output module 155) and may determine whether to generate a rule based on a user input for the inquiry.

When it is determined to generate a rule in operation 1240, the client module 131 may perform operation 1250. When it is determined not to generate a rule in operation 1240, the client module 131 may end the operation according to FIG. 12.

In operation 1250, the client module 131 may transmit a message for agreeing to rule generation to the conversation analysis module 510.

In operation 1260, the conversation analysis module 510 may request the IoT server 520 to generate a rule. In an embodiment, a request for rule generation may include a data set indicating a candidate list.

In operation 1270, the IoT server 520 may generate a rule. In an embodiment, the IoT server 520 may generate a rule based on the candidate list.

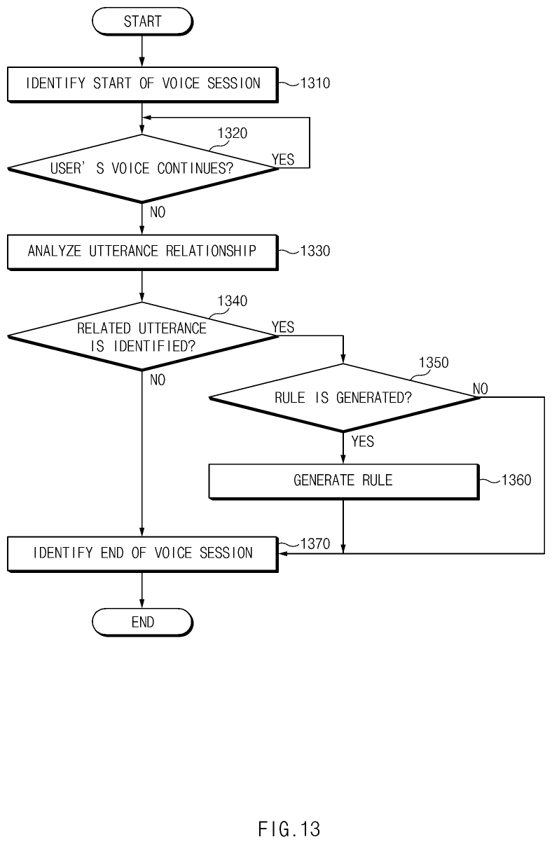

FIG. 13 is a flowchart illustrating an operation of the intelligent server 200, according to an embodiment.

Referring to FIG. 13, in operation 1310, the intelligent server 200 may identify the start of a voice session. The intelligent server 200 may identify the start of the voice session based on a conversation start notification received from the electronic device 101.

In operation 1320, the intelligent server 200 may determine whether a user's voice continues.

For example, when a voice input is received from the electronic device 101, the intelligent server 200 may determine that the user's voice continues. As another example, when the voice input is not received from the electronic device 101 during the specified time, the intelligent server 200 may determine that the user's voice does not continue. As another example, the intelligent server 200 may determine that the user's voice does not continue, based on a conversation end notification from the electronic device 101.

When it is determined in operation 1320 that the user's voice continues, the intelligent server 200 may perform operation 1320. When it is determined in operation 1320 that the user's voice does not continue, the intelligent server 200 may perform operation 1330.

In operation 1330, the intelligent server 200 may analyze an utterance relationship for the received user utterance(s). The intelligent server 200 may identify an utterance including first intent among a plurality of utterances.

For example, the first intent may be intent of an utterance, which is first identified, from among the plurality of utterances related to an IoT device. As another example, the first intent may be intent, which is most frequently indicated by meta data of each of a plurality of utterances related to an IoT device, and/or intent of an utterance related to the IoT device.

In operation 1340, the intelligent server 200 may determine whether a related utterance is identified. In an embodiment, the intelligent server 200 may determine whether an utterance related to an utterance of the first intent is identified in the input user utterances.

In an embodiment, the related utterance may be an utterance related to an IoT device indicated by meta data related to the first intent and/or an utterance related to intent. For example, when the first intent is intent (e.g., PowerSwitch-On) of an the utterance of “turn on an air conditioner”, the related utterance may be an utterance (e.g., turn off the fan) related to an IoT device (e.g., a fan and a thermostat) indicated by meta data (i.e., meta data for an air conditioner) related to the first intent and/or an utterance associated with intent (e.g., Mode-ChangeMode, TemperatureCooling-Set, or WindStrenth-SetMode).

In an embodiment, the related utterance may be an utterance related to an IoT device indicated by meta data related to intent of the related utterance and/or an utterance related to intent. For example, the related utterance may include an utterance (a first related utterance) related to an utterance of the first intent, an utterance (a second related utterance) related to a first related utterance, or an utterance (an (N+1)-th related utterance) related to an N-th related utterance.

When it is determined in operation 1340 that the related utterance is identified, the intelligent server 200 may perform operation 1350. When it is determined in operation 1340 that the related utterance is not identified, the intelligent server 200 may perform operation 1370.

In operation 1350, the intelligent server 200 may determine whether to generate a rule.

The intelligent server 200 may inquire of the electronic device 101 whether to generate a rule and may determine whether to generate the rule based on a response from the electronic device 101.

When it is determined to generate the rule in operation 1350, the intelligent server 200 may perform operation 1360. When it is determined not to generate the rule in operation 1350, the intelligent server 200 may perform operation 1370.

In operation 1360, the intelligent server 200 may generate the rule. The intelligent server 200 may generate the rule by requesting the IoT server 520 to generate the rule. The rule generation request of the intelligent server 200 may include data for a candidate list.

In operation 1370, the intelligent server 200 may identify the end of a voice session.

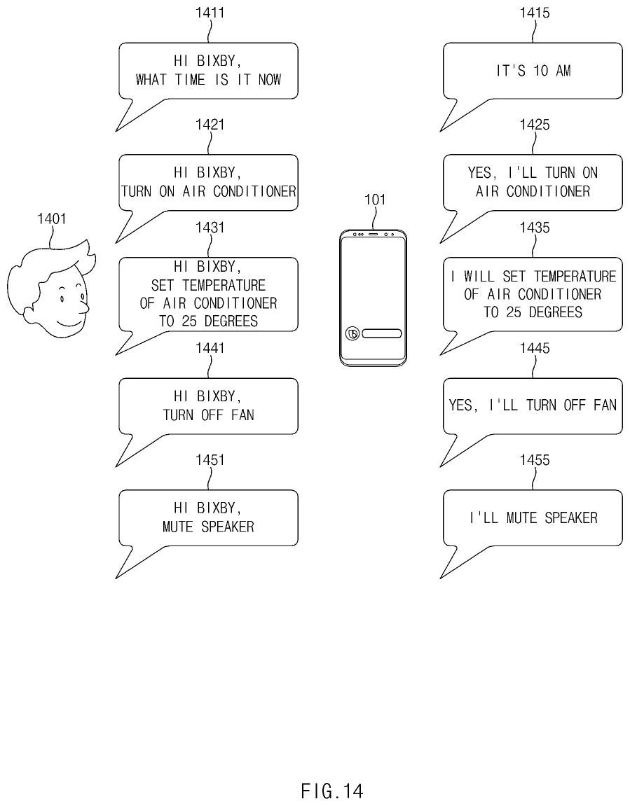

FIG. 14 illustrates a voice recognition service providing situation, according to an embodiment.

A recognition service providing situation of FIG. 14 may indicate a situation according to operation 611 and operation 670 of FIG. 6.

Referring to FIG. 14, a user 1401 may make a request for a voice recognition service to the electronic device 101 through a plurality of utterances 1411, 1421, 1431, 1441, and 1451.

The electronic device 101 may request the intelligent server 200 to perform a task according to the plurality of utterances 1411, 1421, 1431, 1441, and 1451 and may output messages 1415, 1425, 1435, 1445, and 1455 indicating an execution result of a task received from the intelligent server 200.

The intelligent server 200 may generate a rule based on the plurality of utterances 1411, 1421, 1431, 1441, and 1451.

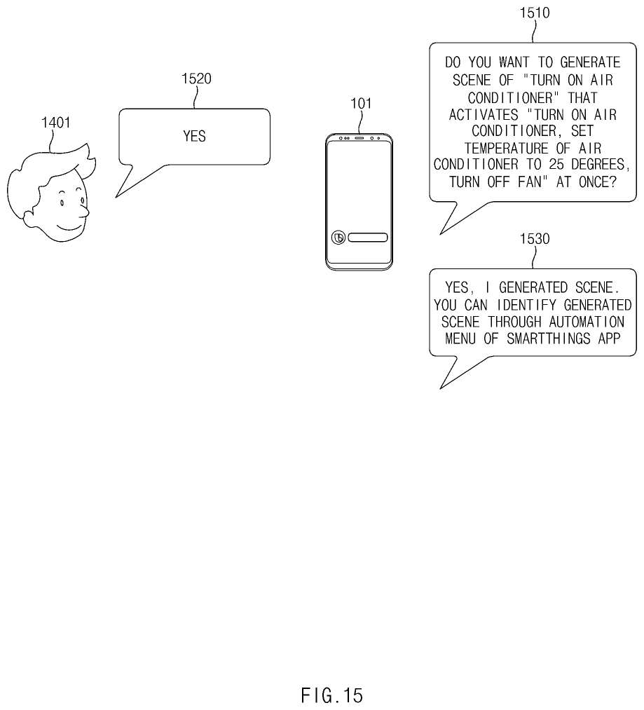

FIG. 15 illustrates a voice recognition service providing situation, according to an embodiment.

A recognition service providing situation of FIG. 15 may indicate a situation according to operation 1230, operation 1240, and operation 1250 of FIG. 12.

The recognition service providing situation of FIG. 15 may occur after the recognition service providing situation of FIG. 14.

Referring to FIG. 15, the electronic device 101 may output a message 1510 for querying rule generation.

The electronic device 101 may obtain a response 1520 to the message 1510 uttered by the user 1401.

When the response 1520 indicates agreement to the rule generation, the electronic device 101 may output a message 1530 indicating that a rule is generated.

When the response 1520 indicates the agreement to the rule generation, the electronic device 101 may request the intelligent server 200 to generate the rule, and the intelligent server 200 may request the IoT server 520 to generate the rule based on the request of the electronic device 101.

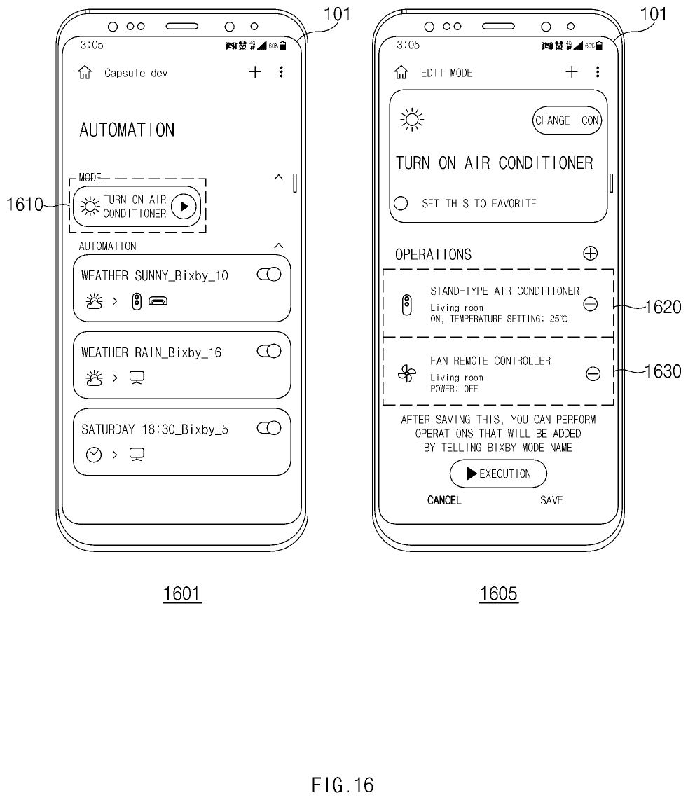

FIG. 16 illustrates a user interface of the electronic device 101, according to an embodiment.

A user interface of FIG. 16 is a user interface for the rule generated depending on FIG. 15.

Referring to FIG. 16, a screen 1601 of a voice recognition service provided by the electronic device 101 may include an image object 1610 indicating the generated rule.

When a user selects the image object 1610 indicating the generated rule, the electronic device 101 may display a screen 1605 for managing the generated rule.

A screen 1605 may include areas 1620 and 1630 indicating information about an IoT device controlled depending on the generated rule.

Each of the areas 1620 and 1630 may include a name (e.g., a stand-type air conditioner or a fan remote controller) of an IoT device and control information (on, temperature setting: 25° C., power: off).

The user may further add an IoT device and/or remove an included IoT device, by applying a user input to the screen 1605.

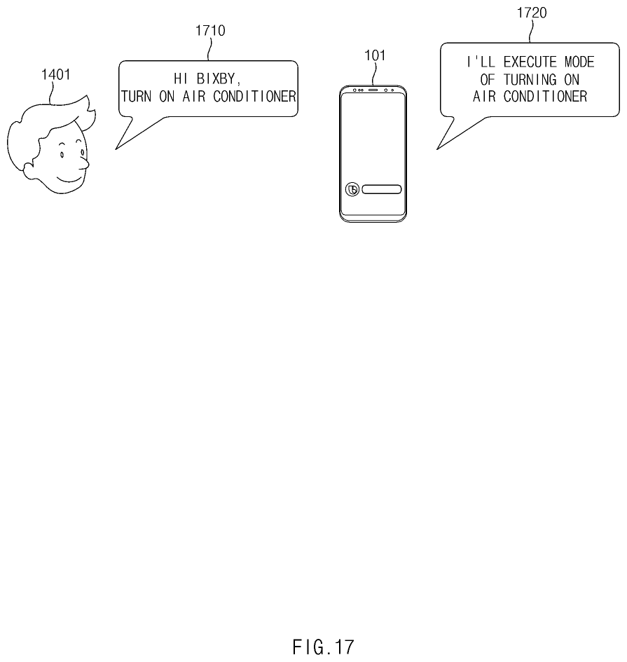

FIG. 17 illustrates a voice recognition service providing situation, according to an embodiment.

A recognition service providing situation of FIG. 17 may occur after the recognition service providing situation of FIG. 15.

Referring to FIG. 17, the electronic device 101 may obtain a user input 1710 requesting the execution of a rule.

The electronic device 101 may request the intelligent server 200 to execute the rule based on receiving the user input 1710. The intelligent server 200 may request the IoT server 520 to execute the rule based on the request of the electronic device 101, The IoT server 520 may control IoT devices associated with the rule, which is requested to be executed, based on the requested rule.

The electronic device 101 may receive feedback according to the rule execution from the intelligent server 200 and may provide the user 1401 with a message 1720 indicating the received feedback.

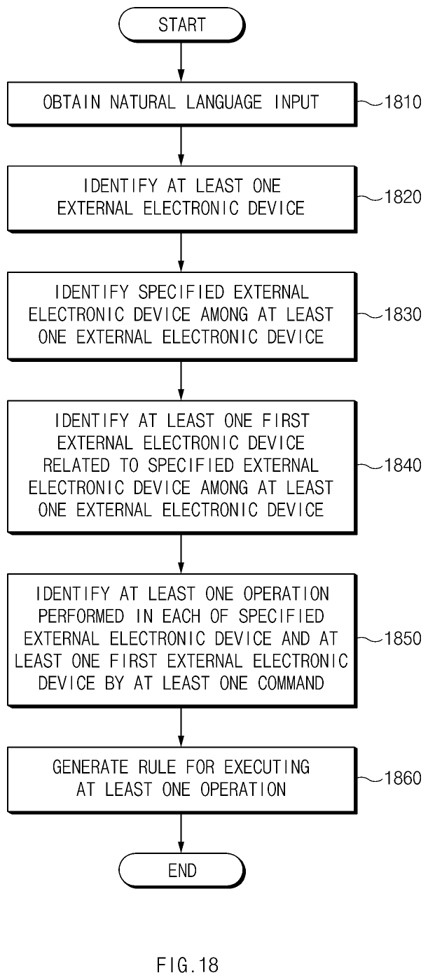

FIG. 18 is a flowchart illustrating an operation of the electronic device 101, according to an embodiment.

The electronic device 101 may include at least some of the functional components of the intelligent server 200. For example, the electronic device 101 may include the ASR module 221, the NLU module 223, the execution engine 240, the TTS module 229, the conversation analysis module 510 of the intelligent server 200, or a combination thereof.

In the description of FIG. 18, it is assumed that the electronic device 101 includes all functional components of the intelligent server 200.

Referring to FIG. 18, in operation 1810, the electronic device 101 may obtain a natural language input.

In operation 1820, the electronic device 101 may identify at least one external electronic device. The at least one external electronic device may be an IoT device. The electronic device 101 may identify at least one external electronic device based on a plurality of utterances included in the natural language input. The at least one external electronic device may be a device for performing a task related to at least one utterance among the plurality of utterances.

In operation 1830, the electronic device 101 may identify a specified external electronic device among the at least one external electronic device.

The specified external electronic device may be an external electronic device related to first intent. For example, the first intent may be intent of an utterance, which is first identified, from among the plurality of utterances related to an external electronic device. As another example, the first intent may be intent, which is most frequently indicated by meta data of each of the plurality of utterances related to an external electronic device, and/or intent of an utterance related to an external electronic device.

The electronic device 101 may store device-related information about the specified external electronic device, which is identified, in the candidate list and may obtain and manage meta data for the specified external electronic device, which is identified, from the meta data server 530.

In operation 1840, the electronic device 101 may identify at least one first external electronic device related to the specified external electronic device among the at least one external electronic device.

In an embodiment, the first external electronic device may be an external electronic device, which is indicated by meta data related to the first intent, and/or an external electronic device related to an intent among external electronic devices according to the plurality of utterances. In an embodiment, the first external electronic device may be an external electronic device, which is indicated by meta data of the first external electronic device, and/or an external electronic device related to an intent among external electronic devices according to the plurality of utterances.

The electronic device 101 may store device-related information about the first external electronic device, which is identified, in the candidate list and may obtain and manage meta data for the first external electronic device, which is identified, from the meta data server 530.

In operation 1850, the electronic device 101 may identify at least one operation performed in each of the specified external electronic device and the at least one first external electronic device by at least one command. At least one command may correspond to a task. At least one operation may include an operation for performing the task.

In operation 1860, the electronic device 101 may generate a rule for executing at least one operation. In an embodiment, the electronic device 101 may generate the rule by requesting the IoT server 520 to generate the rule. The rule generation request may include data for a candidate list.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a processor, and
a memory configured to store instructions that are computer-executable,
wherein the instructions, when executed by the processor, cause the electronic device to:
identify at least one external electronic device associated with at least one command received in a natural language input;
identify a specified external electronic device among the at least one external electronic device;
identify at least one first external electronic device associated with the specified external electronic device among the at least one external electronic device;
identify at least one operation performed by each of the specified external electronic device and the at least one first external electronic device in response to the at least one command; and
generate a rule for executing the at least one operation.

2. The electronic device of claim 1, wherein the natural language input is composed of a plurality of utterances, and
wherein the instructions, when executed by the processor, cause the electronic device to:
obtain the plurality of utterances sequentially; and
identify an external electronic device, which is first identified, from among the at least one external electronic device sequentially identified for each of the plurality of utterances as the specified external electronic device.

3. The electronic device of claim 1, wherein the instructions, when executed by the processor, cause the electronic device to:
obtain meta data of each of the at least one external electronic device; and
identify an external electronic device, which is indicated by first meta data of the specified external electronic device, from among the at least one external electronic device as the at least one first external electronic device.

4. The electronic device of claim 3, wherein the instructions, when executed by the processor, cause the electronic device to:
identify an external electronic device, which is indicated by second meta data of the at least one first external electronic device, from among the at least one external electronic device as the at least one first external electronic device.

5. The electronic device of claim 3, further comprising:
wherein the instructions, when executed by the processor, cause the electronic device to:
receive the meta data for each of the at least one external electronic device from a server,
wherein the meta data is at least one of data generated by a manufacturer of the at least one external electronic device or reference data corresponding to a device type of the at least one external electronic device.

6. The electronic device of claim 1, further comprising:
wherein the instructions, when executed by the processor, cause the electronic device to:
obtain a specified input indicating a rule; and
control the specified external electronic device and the at least one first external electronic device based on the specified input such that the at least one operation according to the rule is executed.

7. The electronic device of claim 1, further comprising:
wherein the instructions, when executed by the processor, cause the electronic device to:
receive the natural language input from a terminal distinguished from the electronic device;
inquire of the terminal whether to generate the rule;
receive confirmation of generation of the rule from the terminal; and
generate the rule in response to receiving the confirmation.

8. The electronic device of claim 1, wherein the instructions, when executed by the processor, cause the electronic device to:
obtain meta data of each of the at least one external electronic device;
identify a degree of association of each of the at least one external electronic device based on the meta data; and
identify an external electronic device, which has the highest degree of association, from among the at least one external electronic device as the specified external electronic device.

9. The electronic device of claim 8, wherein the degree of association of an external electronic device is identified based on the number of external electronic devices, each of which is indicated by the meta data as the external electronic device, from among the at least one external electronic device.

10. The electronic device of claim 1, wherein the at least one external electronic device is an internet of things (IoT) device, and
wherein the electronic device is a server providing a voice recognition service.

11. An operating method of an electronic device, the method comprising:
receiving a natural language input through the electronic device;
identifying at least one external electronic device associated with at least one command included in the natural language input;
identifying a specified external electronic device among the at least one external electronic device;
identifying at least one first external electronic device associated with the specified external electronic device among the at least one external electronic device;
identifying at least one operation performed by each of the specified external electronic device and the at least one first external electronic device by the at least one command; and
generating a rule for executing the at least one operation.

12. The method of claim 11, wherein the natural language input comprises a plurality of utterances, and
wherein the identifying of the specified external electronic device comprises:
obtaining the plurality of utterances sequentially; and
identifying an external electronic device, which is first identified, from among the at least one external electronic device sequentially identified by the plurality of utterances as the specified external electronic device.

13. The method of claim 11, wherein the identifying of the at least one first external electronic device comprises:
obtaining meta data of each of the at least one external electronic device; and
identifying an external electronic device, which is indicated by first meta data of the specified external electronic device, from among the at least one external electronic device as the at least one first external electronic device.

14. The method of claim 13, wherein the identifying of the at least one first external electronic device comprises:
identifying an external electronic device, which is indicated by second meta data of the at least one first external electronic device, from among the at least one external electronic device as the at least one first external electronic device.

15. The method of claim 13, further comprising:
receiving the meta data for each of the at least one external electronic device from a server,
wherein the meta data is at least one of data generated by a manufacturer of the at least one external electronic device or reference data corresponding to a device type of the at least one external electronic device.

16. The method of claim 11, further comprising:
obtaining a specified input indicating a rule through the input module; and
controlling the specified external electronic device and the at least one first external electronic device by using a communication module of the electronic device based on the specified input such that the at least one operation according to the rule is executed.

17. The method of claim 11, wherein the generating of the rule comprises:
obtaining the natural language input from a terminal distinguished from the electronic device by using a communication module of the electronic device;
inquiring of the terminal whether to generate the rule, by using the communication module;
receiving confirmation of generation of the rule from the terminal by using the communication module; and
generating the rule in response to receiving the confirmation.

18. The method of claim 11, wherein the identifying of the specified external electronic device comprises:
obtaining meta data of each of the at least one external electronic device;
identifying a degree of association of each of the at least one external electronic device based on the meta data; and
identifying an external electronic device, which has the highest degree of association, from among the at least one external electronic device as the specified external electronic device.

19. The method of claim 18, wherein the degree of association of an external electronic device is identified based on the number of external electronic devices, each of which is indicated by the meta data as the external electronic device, from among the at least one external electronic device.

20. The method of claim 11, wherein the at least one external electronic device is an IoT device, and
wherein the electronic device is a server providing a voice recognition service.
